(19) United States
(12) Patent Application Publication
(10) Pub. No.: US 2016/0127048 A1
(43) Pub. Date: May 5, 2016

(54) SIGNAL PROCESSING METHOD, DETECTION METHOD, AND DETECTION DEVICE

(71) Applicants: THE UNIVERSITY OF TOKYO, Tokyo (JP); ALNAIR LABS CORPORATION, Tokyo (JP)

(72) Inventors: Kazuro KIKUCHI, Tokyo (JP); Sze, Yun SET, Tokyo (JP)

(21) Appl. No.: 14/890,416

(22) PCT Filed: May 22, 2014
(86) PCT No.: PCT/JP2014/063588

§ 371 Date: Nov. 10, 2015

(30) Foreign Application Priority Data
May 24, 2013 (JP) 2013-110361
May 27, 2013 (JP) 2013-111219

(51) Int. Cl. H04B 10/61

(52) U.S. Cl. CPC H04B 10/612

(57) ABSTRACT

Provided is a signal processing method including a step of acquiring a plurality of Stokes parameters related to polarization in which X polarization and Y polarization included in a dual-polarization phase-shift keying (DP-PSK) signal are defined as an x component and a y component, respectively, and a step of acquiring a two-dimensional constellation diagram by orthographically projecting coordinates defined by each of the Stokes parameters, in a Poincare sphere coordinate system, onto a plane including coordinates (0, 1, 0), (0, 0, 1), (0, −1, 0) and (0, 0, −1).

### TECHNICAL FIELD

The present invention relates to a signal processing method, a detection method and a detection device.

### BACKGROUND ART

Recently, various optical sampling systems have been proposed. Non-Patent Document 1 proposes a linear sampling system as the optical sampling system. Non-Patent Document 1 discloses that a constellation diagram is generated using interference with a sampling pulse. Non-Patent Document 2 discloses dual-channel linear optical sampling. In Non-Patent Document 2, the dual-channel linear optical sampling delayed by one symbol is used. In Non-Patent Document 2, differential phase shift keying (DPSK) is observed by this system.

As other examples, Patent Document 1 discloses a digital coherent receiver. In Patent Document 1, the state of polarization of a polarization multiplexed optical signal is optimized. Patent Document 1 discloses that this optimization can improve the reduction and stability of a load of digital signal processing using a digital signal processor.

### RELATED DOCUMENTS

### Patent Document

[Patent Document 1] Japanese Unexamined Patent Publication No. 2012-238941

### Non-Patent Documents

[Non-Patent Document 1] C. Dorrer, C. R. Doerr, and I. Kang, “Measurement of eye diagram and constellation diagrams of optical sources using linear optics and waveguide technology”, J. Lightwave Technol., vol. 23, pp. 178-186, January 2005.
[Non-Patent Document 2] K. Okamoto and F. Ito, “Ultrafast measurement of optical DPSK signals using 1-symbol delayed dual-channel linear optical sampling”, IEEE Photon. Technol. Lett., vol. 20, pp. 948-950, 2008.

### SUMMARY OF THE INVENTION

A constellation diagram may be used in the measurement of a dual-polarization phase-shift keying (DP-PSK) signal. The acquisition of a constellation diagram of the DP-PSK signal may require receiving a DP-PSK signal by a receiver operating at a low rate. The inventors have examined that a constellation diagram of the DP-PSK signal is acquired by a receiver operating at a low rate.

According to the present invention, there is provided a signal processing method including: a step of acquiring a plurality of Stokes parameters related to polarization in which X polarization and Y polarization included in a dual-polarization phase-shift keying (DP-PSK) signal are defined as an x component and a y component, respectively; and a step of acquiring a two-dimensional constellation diagram by orthographically projecting coordinates defined by each of the Stokes parameters, in a Poincare sphere coordinate system, onto a plane including coordinates (0, 1, 0), (0, 0, 1), (0, −1, 0) and (0, 0, −1).

According to the present invention, there is provided a detection device including: a Stokes parameter acquisition unit that acquires a plurality of Stokes parameters related to polarization in which X polarization and Y polarization included in a DP-PSK signal are defined as an x component and a y component, respectively; and a constellation diagram acquisition unit that acquires a two-dimensional constellation diagram by orthographically projecting coordinates defined by each of the Stokes parameters, in a Poincare sphere coordinate system, onto a plane including coordinates (0, 1, 0), (0, 0, 1), (0, −1, 0) and (0, 0, −1).

According to the present invention, even if a receiver operating at a low rate is used, a constellation diagram of a DP-PSK signal can be obtained.

### BRIEF DESCRIPTION OF THE DRAWINGS

The above-mentioned objects, other objects, features and advantages will be made clearer from the preferred embodiment described below, and the following accompanying drawings.

FIG. 1 is a schematic diagram of a detection device in an embodiment.

FIG. 2 is a diagram illustrating phase states which are displayed in a Poincare sphere coordinate system in DP-PSK.

FIG. 3 is a diagram illustrating phase states which are displayed in the Poincare sphere coordinate system in DP-PSK.

FIG. 4 is a diagram illustrating simulation results of a constellation diagram.

FIG. 5 is a diagram illustrating experimental results of the constellation diagram.

### DESCRIPTION OF EMBODIMENTS

Hereinafter, an embodiment of the present invention will be described with reference to the accompanying drawings. In all the drawings, like elements are referenced by like reference numerals and descriptions thereof will not be repeated.

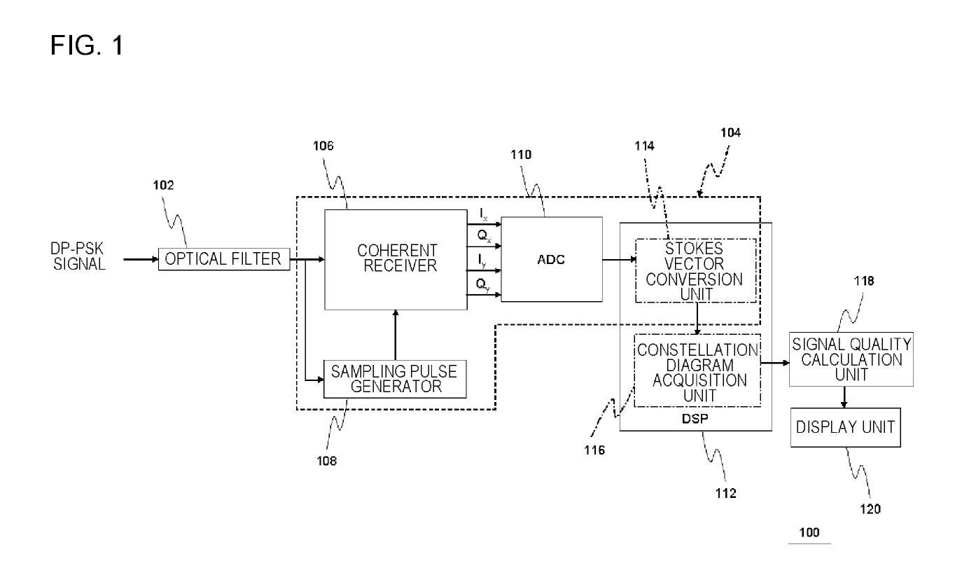

FIG. 1 is a schematic diagram of a detection device 100 in an embodiment. FIG. 1 is a schematic diagram illustrating the detection device 100, and the configuration of the detection device 100 is not limited to that shown in FIG. 1. As shown in FIG. 1, the detection device 100 includes a Stokes parameter acquisition unit 104 and a constellation diagram acquisition unit 116. The Stokes parameter acquisition unit 104 acquires a plurality of Stokes parameters related to polarization. In the polarization of the present embodiment, X polarization and Y polarization included in a dual-polarization phase-shift keying (DP-PSK) signal are defined as an x component and a y component, respectively. The constellation diagram acquisition unit 116 acquires a two-dimensional constellation diagram. The constellation diagram in the present embodiment is acquired by orthographically projecting coordinates defined by each of the Stokes parameters, in a Poincare sphere coordinate system, onto a plane including coordinates (0, 1, 0), (0, 0, 1), (0, −1, 0) and (0, 0, −1).

The details of the detection device 100 in the present embodiment will be described below. As shown in FIG. 1, the detection device 100 includes the Stokes parameter acquisition unit 104 and the constellation diagram acquisition unit 116. The Stokes parameter acquisition unit 104 includes a coherent receiver 106, a sampling pulse generator 108, an analog-to-digital converter (ADC) 110, and a Stokes vector converter 114. The Stokes vector converter 114 and the constellation diagram acquisition unit 116 are included in a digital signal processor (DSP) 112. As shown in FIG. 1, the detection device 100 further includes an optical filter 102.

An operation of the detection device 100 will be described below. In the detection device 100, the dual-polarization phase-shift keying (DP-PSK) signal is input to the coherent receiver 106 and the sampling pulse generator 108 through the optical filter 102. The DP-PSK signal includes the X polarization and the Y polarization. The X polarization and the Y polarization intersect at right angles to each other. In the DP-PSK signal, the phase is modulated in each of the X polarization and the Y polarization. In this case, the modulations of the phases are independent of each other in the X polarization and the Y polarization. In the present embodiment, the X polarization and the Y polarization of the DP-PSK signal have intensities equal to each other. The X polarization and the Y polarization of the DP-PSK signal are emitted from the same light source (for example, laser light source). In the present embodiment, the phases of the DP-PSK signal in the X polarization and the Y polarization can be applied to a 2^{N} phase (N≧1). When the phases in the X polarization and the Y polarization are set to the 2^{N} phase, binary data can be carried on each of the X polarization and the Y polarization of the DP-PSK signal.

A specific example of the DP-PSK signal includes a dual-polarization quadrature phase-shift keying (DP-QPSK) signal, a dual-polarization binary phase-shift keying (DP-BPSK) signal, or a dual-polarization 8 phase-shift keying (DP-8PSK) signal. In the present embodiment, the DP-QPSK signal may have a transmission rate equal to or greater than 100 Gbit/sec. In the DP-BPSK signal, a phase in the X polarization is modulated to have two states of “0” and “1” in terms of binary, in an IQ plane, and a phase in the Y polarization is also modulated to have two states of “0” and “1” in terms of binary, in the IQ plane. In the DP-QPSK signal, a phase in the X polarization is modulated to have four states of “00”, “01”, “10” and “11” in terms of binary, in the IQ plane, and a phase in the Y polarization is also modulated to have four states of “00”, “01”, “10” and “11” in terms of binary, in the IQ plane. In the DP-8PSK signal, a phase in the X polarization is modulated to have eight states of “000”, “001”, “010”, “011”, “100”, “101”, “110” and “111” in terms of binary, in the IQ plane, and a phase in the Y polarization is also modulated to have eight states of “000”, “001”, “010”, “011”, “100”, “101”, “110” and “111” in terms of binary, in the IQ plane.

In the detection device 100, as described above, the DP-PSK signal passes through the optical filter 102. The optical filter 102 functions as a filter that removes noise of the DP-PSK signal. Thereby, a carrier-to-noise ratio (CNR) of the DP-PSK signal is improved.

In the detection device 100, the Stokes parameter acquisition unit 104 acquires a Stokes parameter related to the input DP-PSK signal. In the detection device 100, the Stokes parameter is obtained from the DP-PSK signal by linear sampling.

The details of the linear sampling are as follows. First, a portion of the DP-PSK signal passing through the optical filter 102 is input to the sampling pulse generator 108. The sampling pulse generator 108 extracts a symbol rate T of the DP-PSK signal. The sampling pulse generator 108 frequency-divides the symbol rate T by n (where, n is a sufficiently large positive integer), and generates a sampling light pulse of the sampling frequency 1/(nT). The generated sampling light pulse is output to the coherent receiver 106.

The remaining portion of the DP-PSK signal passing through the optical filter 102 is input to the coherent receiver 106. The coherent receiver 106 has a polarization beam splitter (PBS) therein. The coherent receiver 106 splits the X polarization and the Y polarization of the DP-PSK signal using the PBS. The coherent receiver 106 linearly detects each of the X polarization and the Y polarization of the DP-PSK signal, using the sampling light pulse from the sampling light pulse generator 108 as a local oscillator (LO). Thereafter, the coherent receiver 106 outputs electrical signals Iₓ and Qₓ related to an I channel and a Y channel of the X polarization, and electrical signals I_{y} and Q_{y} related to an I channel and a Y channel of the Y polarization.

The electrical signals Iₓ, Qₓ, I_{y} and Q_{y} which are output from the coherent receiver 106 are input to the ADC 110. The ADC 110 analog-to-digital converts the electrical signals Iₓ, Qₓ, I_{y} and Q_{y}. The signals analog-to-digital converted in the ADC 110 are output to the DSP 112.

In the DSP 112, the Stokes vector converter 114 obtains a component Eₓ(k) of the X polarization and a component E_{y}(k) of the Y polarization in the DP-PSK signal from the electrical signals Iₓ, Qₓ, I_{y} and Q_{y} that are analog-to-digital converted in the ADC 110 (where, k is the number of samples). The Stokes vector converter 114 calculates Stokes parameters S₁, S₂ and S₃ from Eₓ (k) and E_{y}(k), using the following Expressions (1) to (3).

[Mathematical 1]

S₁=|Eₓ(k)|²−|E_{y}(k)|² (1)

S₂=2|Eₓ(k)∥E_{y}(k)|cos(θ(k)) (2)

S₃=2|Eₓ(k)∥E_{y}(k)|sin(θ(k)) (3)

where θ(k)=arg(Eₓ(k)/E_{y}(k)).

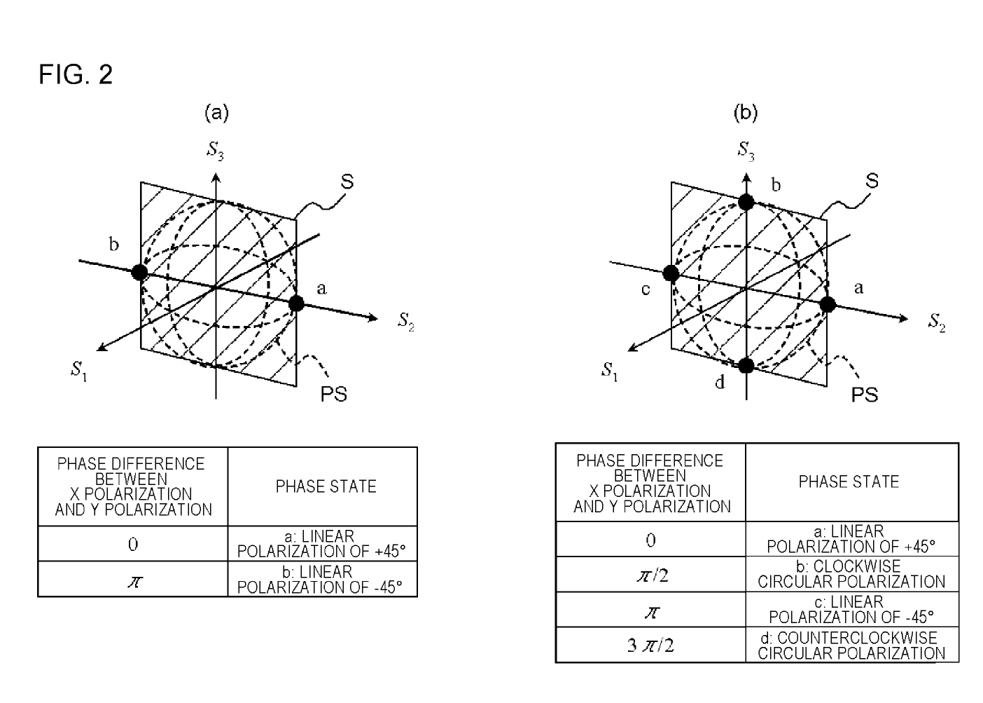

The Stokes parameters S₁, S₂ and S₃ denote the state of polarization (SOP) of the DP-PSK signal which is input to the detection device 100. The SOP denoted by the Stokes parameters S₁, S₂ and S₃ is displayed in the Poincare sphere coordinate system. The SOP which is displayed in the Poincare sphere coordinate system will be described with reference to FIG. 2.

FIG. 2(a) is a diagram illustrating SOPs which is displayed in the Poincare sphere coordinate system in DP-BPSK. In the Poincare sphere coordinate system, axes S₁, S₂ and S₃ intersect at right angles to each other. In FIG. 2(a), a Poincare sphere PS is schematically illustrated by a broken line. In addition, a plane S indicated by hatching in FIG. 2(a) is a plane including coordinates (0, 1, 0), (0, 0, 1), (0, −1, 0) and (0, 0, −1). Phase differences allowable for the X polarization and the Y polarization in DP-BPSK are 0 and n. In the phase difference of 0, in the Poincare sphere PS, a center a is taken as shown in FIG. 2(a). The SOP in the center a is linear polarization of +45°. On the other hand, in the phase difference of π, in the Poincare sphere PS, a center b is taken as shown in FIG. 2(a). The SOP in the center b is linear polarization of −45°.

FIG. 2(b) is a diagram illustrating SOPs which are displayed in the Poincare sphere coordinate system in DP-QPSK. In the Poincare sphere coordinate system, axes S₁, S₂ and S₃ intersect at right angles to each other. In FIG. 2(b), a Poincare sphere PS is schematically illustrated by a broken line. In addition, a plane S indicated by hatching in FIG. 2(b) is a plane including coordinates (0, 1, 0), (0, 0, 1), (0, −1, 0) and (0, 0, −1). Phase differences allowable for the X polarization and the Y polarization in DP-QPSK are 0, π/2, n and 3π/2. In the phase difference of 0, in the Poincare sphere PS, a center a is taken as shown in FIG. 2(b). The SOP in the center a is linear polarization of +45°. In the phase difference of π/2, in the Poincare sphere PS, a center b is taken as shown in FIG. 2(b). The SOP in the center b is clockwise circular polarization. In the phase difference of π, in the Poincare sphere PS, a center c is taken as shown in FIG. 2(b). The SOP in the center c is linear polarization of −45°. Finally, in the phase difference of 3π/2, in the Poincare sphere PS, a center d is taken as shown in FIG. 2(b). The SOP in the center d is counterclockwise circular polarization.

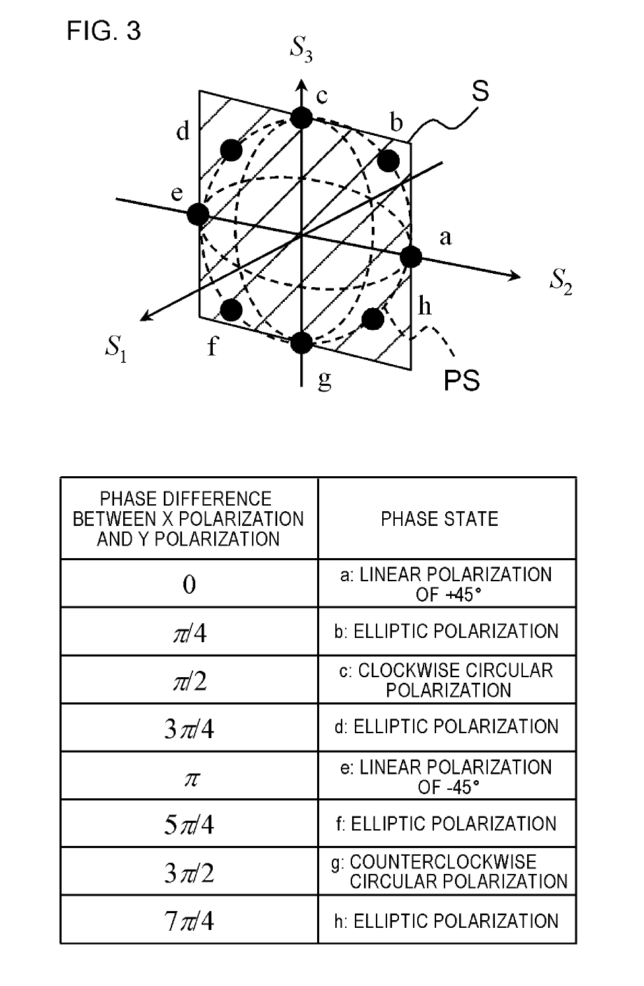

FIG. 3 is a diagram illustrating SOPs which are displayed in the Poincare sphere coordinate system in DP-8PSK. In the Poincare sphere coordinate system, axes S₁, S₂ and S₃ intersect at right angles to each other. In FIG. 3, a Poincare sphere PS is schematically illustrated by a broken line. In addition, a plane S indicated by hatching in FIG. 3 is a plane including coordinates (0, 1, 0), (0, 0, 1), (0, −1, 0) and (0, 0, −1). Phase differences allowable for the X polarization and the Y polarization in DP-8PSK are 0, π/4, π/2, 3π/4, π, 5π/4, 3π/2, and 7π/4. In the phase difference of 0, in the Poincare sphere PS, a center a is taken as shown in FIG. 3. The SOP in the center a is linear polarization of +45°. In the phase difference of π/4, in the Poincare sphere PS, a center b is taken as shown in FIG. 3. The SOP in the center b is elliptic polarization. In the phase difference of π/2, in the Poincare sphere PS, a center c is taken as shown in FIG. 3. The SOP in the center c is clockwise circular polarization. In the phase difference of 3π/4, in the Poincare sphere PS, a center d is taken as shown in FIG. 3. The SOP in the center d is elliptic polarization. In the phase difference of π, in the Poincare sphere PS, a center e is taken as shown in FIG. 3. The SOP in the center e is linear polarization of −45°. In the phase difference of 5π/4, in the Poincare sphere PS, a center f is taken as shown in FIG. 3. The SOP in the center f is elliptic polarization. In the phase difference of 3π/2, in the Poincare sphere PS, a center g is taken as shown in FIG. 3. The SOP in the center g is counterclockwise circular polarization. Finally, in the phase difference of 7π/4, in the Poincare sphere PS, a center h is taken as shown in FIG. 3. The SOP in the center h is elliptic polarization.

In the present embodiment, the SOPs related to the DP-PSK signal are calculated by Expressions (1) to (3), and are displayed as coordinates in the Poincare sphere coordinate system. The constellation diagram acquisition unit 116 orthographically projects the coordinates onto the plane S. Thereby, a constellation diagram displayed two-dimensionally with respect to the DP-PSK signal is obtained.

In the present embodiment, as shown in FIG. 1, the detection device 100 may further include a signal quality calculation unit 118 and a display unit 120. The signal quality calculation unit 118 acquires a Q value of the two-dimensional constellation diagram acquired by the constellation diagram acquisition unit 116. Specifically, the constellation diagram acquisition unit 116 outputs a signal including information of the two-dimensional constellation diagram to the signal quality calculation unit 118. The signal quality calculation unit 118 analyzes the signal which is output from the constellation diagram acquisition unit 116, and acquires the Q value of the two-dimensional constellation diagram. The Q value is a value which is defined by Q=s/2σ (where, s is a distance between constellation points adjacent to each other in the two-dimensional constellation diagram; σ is a standard deviation of the Gaussian distribution of signal intensities in constellation points of the two-dimensional constellation diagram). The signal quality calculation unit 118 outputs a signal including the Q value to the display unit 120. The display unit 120 displays the Q value which is output from the signal quality calculation unit 118. The display unit 120 may be, for example, a liquid crystal display. Thereby, a user of the detection device 100 can confirm the Q value of the DP-PSK signal which is detected by the detection device 100.

The Q value is a value indicating the quality of a signal. For example, when Q>6 is satisfied, the bit error rate of a signal is equal to or less than 10⁻⁹. In the present embodiment, the signal quality calculation unit 118 may calculate a bit error rate from the Q value. In this case, the signal quality calculation unit 118 may output a signal including the bit error rate together with the signal including the Q value to the display unit 120. The display unit 120 may display the bit error rate together with the Q value.

The two-dimensional constellation diagram obtained in the present embodiment is obtained from the Stokes parameters related to the X polarization and the Y polarization of the DP-PSK signal. The Stokes parameter can be calculated without influence of noise of the phase of the DP-PSK signal. Accordingly, the detection device 100 can acquire the two-dimensional constellation diagram without influence of the noise of the DP-PSK signal. In addition, in the present embodiment, since a constellation parameter is calculated through the Stokes parameter, the two-dimensional constellation diagram can be acquired regardless of a symbol rate and a sampling rate. Particularly, even when the DP-PSK signal is a DP-QPSK signal, and the DP-QPSK signal has a transmission rate equal to or greater than 100 Gbit/sec, the detection device 100 of the present embodiment can detect the DP-QPSK signal.

### Example 1

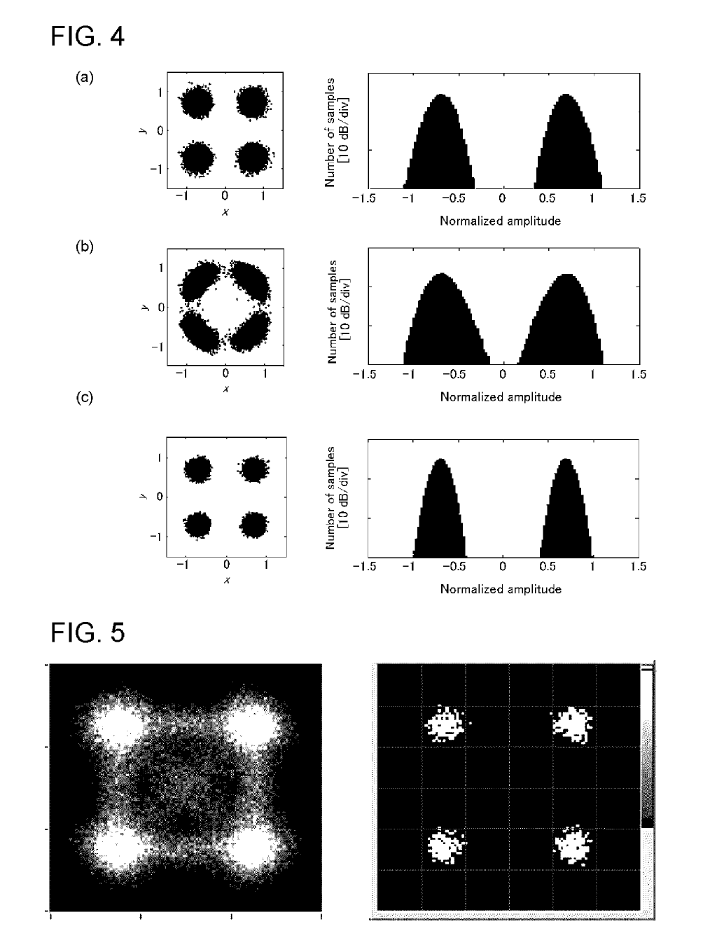

A signal processing method in the present embodiment was analyzed by a simulation. FIG. 4 shows simulation results related to the DP-QPSK signal. In the simulation, the DP-PSK signal was a DP-QPSK signal. The CNR of light output from the optical filter 102 was assumed to be 15 dB. The number of samples was 2¹⁶. The figures on the left side in FIGS. 4(a) to 4(c) show simulation results of the constellation diagram. On the other hand, the figures on the right side in FIGS. 4(a) to 4(c) show histograms of the constellation points in an x direction of the constellation diagram.

FIG. 4(a) shows simulation results related to a constellation diagram obtained by the signal processing method in the present embodiment. The histogram of the constellation points is distributed in a substantial Gaussian shape as shown in the figure on the right in FIG. 4(a). On the other hand, FIG. 4(b) shows simulation results related to a constellation diagram obtained by linear sampling without calculating the Stokes parameter of DP-QPSK. When FIGS. 4(a) and 4(b) are compared with each other, the phase diffusion of the constellation points is prominently shown in the constellation diagram in FIG. 4(b) (the figure on the left in FIG. 4(b)). This is based on the phase noise of the DP-QPSK signal. In addition, the spread of the histogram of the constellation diagram in FIG. 4(b) is larger than the spread of the histogram of the constellation diagram in FIG. 4(a) (the figures on the right in FIGS. 4(a) and 4 (b)). Thus, the signal processing method in FIG. 4(a) may reduce the influence of the phase noise of the DP-QPSK signal more than the signal processing method in FIG. 4(b).

FIG. 4(c) shows simulation results related to a constellation diagram obtained by linear sampling without calculating the Stokes parameter of DP-QPSK. In FIG. 4(c), a constellation diagram is acquired in an ideal condition in which the phase noise of DP-QPSK is not present. When FIGS. 4 (a) and 4 (c) are compared with each other, the dispersion of the constellation diagram in FIG. 4(a) is equal to or greater than 3 dB in relation to the constellation diagram in FIG. 4(c). In this regard, FIG. 4(c) is a result in the ideal condition in which the phase noise of DP-QPSK is not present, whereas FIG. 4(a) is a result in a condition in which the phase noise of DP-QPSK is present. For this reason, despite of the condition in which the phase noise of DP-QPSK is present, the signal processing method in FIG. 4(a) may obtain a result similar to that of the constellation diagram in the ideal condition.

### Example 2

An experiment on the signal processing method in the present embodiment was performed with an actual optical system assembled. Specifically, the optical system shown in FIG. 1 was assembled. More specifically, as the DP-PSK signal, a DP-QPSK signal of 100 Gbit/sec was used. As the coherent receiver 106, optical hybrid dual polarization (DP) −25 Gbaud was used. As the ADC 110, 8-ch A/D 50 MS/s (Mega Samples per Second) was used. A balanced photo diode (BPD) was provided, between the coherent receiver 106 and the ADC 110, to each of signals Iₓ, Qₓ, I_{y}, and Q_{y}. As the sampling pulse generator 108, a mode-locked fiber laser (MLFL) of 50 MHz was used. The sampling pulse generator 108 sends a sampling light pulse to the coherent receiver, and sends a clock to the ADC 110.

FIG. 5 shows experimental results related to a constellation diagram obtained by the aforementioned optical system according to the present example. The left side in the drawing shows raw data of the experimental results. On the other hand, the right side in the drawing is a result obtained by extracting data having a predetermined value (threshold) or greater in the raw data. As shown in the drawing, in the present example, four patterns derived from the DP-QPSK signal were clearly observed. Further, in the present example, the rate of a signal using the DP-QPSK signal is 100 Gbit/sec. In this manner, according to the present example, the signal of a high rate was able to be clearly observed.

This application claims priority from Japanese Patent Application Nos. 2013-110361 filed on May 24, 2013 and 2013-111219 filed on May 27, 2013, the contents of which are incorporated herein by reference in their entireties.

1. A signal processing method comprising:
a step of acquiring a plurality of Stokes parameters related to polarization in which X polarization and Y polarization included in a dual-polarization phase-shift keying (DP-PSK) signal are defined as an x component and a y component, respectively; and
a step of acquiring a two-dimensional constellation diagram by orthographically projecting coordinates defined by each of the Stokes parameters, in a Poincare sphere coordinate system, onto a plane including coordinates (0, 1, 0), (0, 0, 1), (0, −1, 0) and (0, 0, −1).

2. The signal processing method according to claim 1, wherein the DP-PSK signal is a dual-polarization quadrature phase-shift keying (DP-QPSK) signal.

3. The signal processing method according to claim 1, wherein the DP-PSK signal is a dual-polarization binary phase-shift keying (DP-BPSK) signal.

4. The signal processing method according to claim 1, wherein the DP-PSK signal is a dual-polarization 8 phase-shift keying (DP-8PSK) signal.

5. The signal processing method according to claim 2, wherein the DP-QPSK signal has a transmission rate equal to or greater than 100 Gbit/sec.

6. A detection method of acquiring a Q value (where Q=s/2σ; s is a distance between constellation points adjacent to each other in the two-dimensional constellation diagram, and σ is a standard deviation of Gaussian distribution of signal intensities in the constellation points in the two-dimensional constellation diagram) of the two-dimensional constellation diagram acquired by the signal processing method according to claim 1.

7. A detection device comprising:
a Stokes parameter acquisition unit that acquires a plurality of Stokes parameters related to polarization in which X polarization and Y polarization included in a DP-PSK signal are defined as an x component and a y component, respectively; and
a constellation diagram acquisition unit that acquires a two-dimensional constellation diagram by orthographically projecting coordinates defined by each of the Stokes parameters, in a Poincare sphere coordinate system, onto a plane including coordinates (0, 1, 0), (0, 0, 1), (0, −1, 0) and (0, 0, −1).

8. The detection device according to claim 7, wherein the Stokes parameter acquisition unit includes:
a coherent receiver that splits the X polarization and the Y polarization which are included in the DP-PSK signal, and outputs electrical signals corresponding to the X polarization and the Y polarization;
an analog-to-digital converter that analog-to-digital converts the electrical signals which are output by the coherent receiver, and outputs the converted signals; and
a digital signal processor that calculates the Stokes parameters from the electrical signals which are output by the analog-to-digital converter.

9. The detection device according to claim 7, wherein the DP-PSK signal is a DP-QPSK signal.

10. The detection device according to claim 7, wherein the DP-PSK signal is a DP-BPSK signal.

11. The detection device according to claim 7, wherein the DP-PSK signal is a DP-8PSK signal.

12. The detection device according to claim 9, wherein the DP-QPSK signal has a transmission rate equal to or greater than 100 Gbit/sec.

13. The detection device according to claim 7, further comprising a signal quality calculation unit that acquires a Q value (where Q=s/2σ; s is a distance between constellation points adjacent to each other in the two-dimensional constellation diagram, and σ is a standard deviation of Gaussian distribution of signal intensities in the constellation points in the two-dimensional constellation diagram) of the two-dimensional constellation diagram acquired by the constellation diagram acquisition unit.
